(19) United States
(12) Patent Application Publication
(10) Pub. No.: US 2026/0046929 A1
(43) Pub. Date: Feb. 12, 2026

(54) Multi-Access Point Fair Transmit Opportunity Sharing

(71) Applicant: Apple Inc., Cupertino, CA (US)

(72) Inventors: Yong Ho Seok, Cupertino, CA (US); Ahmad Reza Hedayat, Carlsbad, CA (US); Anuj Batra, Redwood City, CA (US); Morteza Mehrnoush, Hayward, CA (US); Su Khiong Yong, Palo Alto, CA (US); Wook Bong Lee, San Jose, CA (US); Yan Zhang, Palo Alto, CA (US); Yanjun Sun, San Diego, CA (US); Yong Liu, Campbell, CA (US)

(21) Appl. No.: 19/296,757

(22) Filed: Aug. 11, 2025

Related U.S. Application Data
(60) Provisional application No. 63/682,136, filed on Aug. 12, 2024.

(51) Int. Cl. H04W 74/0816; H04W 28/02; H04W 74/08

(52) U.S. Cl. CPC H04W 74/0816; H04W 28/0278; H04W 74/0866

(57) ABSTRACT

An electronic device is described. This electronic device can include: an antenna node communicatively coupled to an antenna; and an interface circuit, communicatively coupled to the antenna node, that communicates with a second electronic device. During operation, the interface circuit can determine at least a parameter indicating an amount of time the electronic device shares with at least the second electronic device in one or more TXOPs of at least the electronic device, and a second amount of time the electronic device receives from at least the second electronic device in one or more second TXOPs of at least the second electronic device. Then, the interface circuit can selectively participate in transmit opportunity sharing (TXS) during a subsequent TXOP of the second electronic device based at least in part on at least the parameter and a threshold value.

### CROSS-REFERENCE TO RELATED APPLICATION

This application claims the benefit of U.S. Provisional Application No. 63/682,136, entitled “Multi-Access Point Fair Transmit Opportunity Sharing,” by Yong Ho Seok, et al., filed Aug. 12, 2024, the contents of which are hereby incorporated by reference.

### FIELD

The described embodiments relate, generally, to wireless communication among electronic devices, including fair sharing of a transmit opportunity among two or more access points.

### BACKGROUND

Many electronic devices communicate with each other using wireless local area networks (WLANs), such as those based on a communication protocol that is compatible with an Institute of Electrical and Electronics Engineers (IEEE) 802.11 standard (which is sometimes referred to as ‘Wi-Fi’).

In Wi-Fi communication, sharing a transmit opportunity (TXOP) in a channel with a neighboring access point (AP) can enhance the low-latency traffic quality-of-service (QoS) of a neighboring access point. However, excessive TXOP sharing can also cause unfairness between basic service sets (BSSs). For example, one or more non-access point stations (non-AP STAs) associated with a sharing access point can experience reduced QoS, such as reduced throughput and latency.

### SUMMARY

An electronic device is described. This electronic device includes: an antenna node communicatively coupled to an antenna; and an interface circuit, communicatively coupled to the antenna node, that communicates with a second electronic device. During operation, the interface circuit determines at least a parameter indicating an amount of time the electronic device shares with at least the second electronic device in one or more TXOPs of at least the electronic device, and a second amount of time the electronic device receives from at least the second electronic device in one or more second TXOPs of at least the second electronic device. Then, the interface circuit selectively participates in transmit opportunity sharing (TXS) during a subsequent TXOP of the second electronic device based at least in part on at least the parameter and a threshold value.

Note that the selective participation can be based at least in part on a comparison of at least the parameter and the threshold value.

Moreover, at least the parameter can include a sharing parameter corresponding to the amount of time and a shared parameter corresponding to the second amount of time, where the selective participation can be based at least in part on the sharing parameter, the shared parameter and the threshold value. Note that the selective participation can be based at least in part on a comparison of the sharing parameter and the threshold value, and a second comparison of the shared parameter and the threshold value. Furthermore, the selective participation can be rejected when the comparison and/or the second comparison violate an acceptance criterion. In some embodiments, the acceptance criterion can include a predefined value in a time interval.

Additionally, the electronic device can include an access point and the second electronic device can include a second access point. Note that at least the parameter can be determined on a per-access point basis.

In some embodiments, at least the parameter can be determined on a per-access category basis and the selective participation can be allowed when an access category of data to be communicated during the TXS equals or exceeds a predefined priority. Note that the predefined priority can be associated with a specified access category in the TXS. Moreover, one or more predefined access categories can include voice and/or video.

Furthermore, the selective participation can be allowed for data having one or more predefined access categories. For example, the one or more predefined access categories can include voice and/or video.

Additionally, at least the parameter can ensure fairness, during the TXS, among electronic devices, which can include the electronic device and the second electronic device.

In some embodiments, the interface circuit can receive data or provide a trigger frame to one or more associated stations of the electronic device during a TXOP and prior to the TXS. Moreover, the interface circuit can receive, associated with the one or more stations, a block acknowledgement.

Furthermore, the interface circuit can receive, associated with the second electronic device, the TXS. Additionally, when the TXS during the at least the subsequent TXOP is rejected, the interface circuit can provide, addressed to the second electronic device, information indicating that the TXS during the at least the subsequent TXOP is rejected. Note that the information can be included in: a clear-to-send (CTS) frame; or a buffer status report (BSR).

In some embodiments, the TXS can be included in: a multi-user request-to-send (RTS) frame; or a buffer status report poll (BSRP).

Moreover, at least the parameter can be determined on behalf of the electronic device and at least the second electronic device.

Other embodiments provide the second electronic device that performs counterpart operations to at least some of the operations performed by the electronic device. For example, the second electronic device can include: an antenna node communicatively coupled to an antenna; and an interface circuit, communicatively coupled to the antenna node, that communicates with the electronic device. During operation, the interface circuit provides, addressed to the electronic device, a TXS during a subsequent TXOP. Then, the interface circuit receives, associated with the electronic device, information indicating whether the TXS is accepted.

Other embodiments provide an integrated circuit (such as the interface circuit) for use with the electronic device or the second electronic device. The integrated circuit can perform at least some of the aforementioned operations of the electronic device or the second electronic device.

Other embodiments provide a computer-readable storage medium for use with the electronic device or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments provide a method. The method includes at least some of the aforementioned operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that can be made to the embodiments by one skilled in the art without departing from the spirit and scope of the embodiments. The embodiments will be readily understood by the following detailed description in conjunction with the accompanying drawings, where like reference numerals designate like structural elements.

FIG. 1 is a block diagram illustrating an example of communication between electronic devices.

FIG. 2 is a block diagram illustrating an example of communication between electronic devices.

FIG. 3 is a flow diagram illustrating an example method for selectively participating in transmit opportunity sharing (TXS) using an electronic device of FIG. 1 or 2.

FIG. 4 is a flow diagram illustrating an example method for receiving information indicating whether a TXS is accepted using an electronic device of FIG. 1 or 2.

FIGS. 5-15 are drawings illustrating examples of communication between the electronic devices of FIG. 1 or 2.

FIG. 16 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

An electronic device (such as an access point) is described. This electronic device can include: an antenna node communicatively coupled to an antenna; and an interface circuit, communicatively coupled to the antenna node, that communicates with a second electronic device (such as a second access point). During operation, the interface circuit can determine at least a parameter indicating an amount of time the electronic device shares with at least the second electronic device in one or more TXOPs of at least the electronic device, and a second amount of time the electronic device receives from at least the second electronic device in one or more second TXOPs of at least the second electronic device. Then, the interface circuit can selectively participate in TXS during a subsequent TXOP of the second electronic device based at least in part on at least the parameter and a threshold value.

By determining the parameter, these communication techniques can improve performance during the TXS. For example, the communication techniques can maintain throughput and latency of an access point and one or more associated stations by limiting an amount of time the access point can participate in TXS with one or more neighboring access points. In these ways, the communication techniques can improve the user experience when using the electronic device, the second electronic device and/or the one or more associated stations.

In the discussion that follows, a user can include: an individual, an organization, a company, a governmental agency, a for-profit business entity, a not-for-profit entity, or a group of one or more individuals.

Note that the communication techniques can be used during or with wired or wireless communication between electronic devices in accordance with a communication protocol, such as a communication protocol that is compatible with an IEEE 802.11 standard (which is sometimes referred to as Wi-Fi). However, the communication techniques can also be used with a wide variety of other communication protocols, and in electronic devices (such as portable electronic devices or mobile devices) that can incorporate multiple different radio access technologies (RATs) to provide connections through different wireless networks that offer different services and/or capabilities.

The electronic device and/or the second electronic device can include hardware and software to support a wireless personal area network (WPAN) according to a WPAN communication protocol, such as those standardized by the Bluetooth Special Interest Group and/or those developed by Apple (in Cupertino, California) that are referred to as an Apple Wireless Direct Link (AWDL). Moreover, the electronic device and/or the second electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device and/or the second electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, IEEE 802.11me, IEEE 802.11bn, IEEE 802.11bx, IEEE 802.11mf or other present or future developed IEEE 802.11 technologies.

Note that the electronic device and/or the second electronic device can use multi-user transmission (such as OFDMA) and/or multiple-input multiple-output (MIMO).

In some embodiments, the electronic device and/or the second electronic device can act as a communications hub that provides access to a WLAN and/or to a WWAN and, thus, to a wide variety of services that can be supported by various applications executing on the electronic device and/or the second electronic device. Thus, the electronic device and/or the second electronic device can include an ‘access point’ that communicates wirelessly with other electronic devices (such as using Wi-Fi), and that provides access to another network (such as the Internet) via IEEE 802.3 (which is sometimes referred to as ‘Ethernet’). Note that the access point can be a physical access point or a virtual or ‘software’ access point that is implemented on a computer or an electronic device. However, in other embodiments the electronic device and/or the second electronic device may not be an access point.

Additionally, it should be understood that the electronic devices described herein can be configured as multi-mode wireless communication devices that are also capable of communicating via different 3G and/or second generation (2G) RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein can be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) can be used herein to describe one or more consumer electronic devices that can be capable of performing procedures associated with various embodiments of the disclosure.

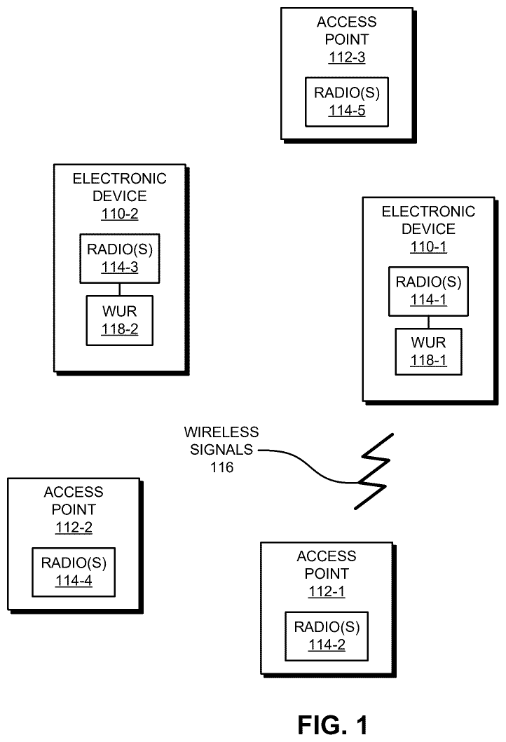

FIG. 1 presents a block diagram illustrating an example of electronic devices communicating wirelessly. Notably, one or more electronic devices 110 (such as a smartphone, a laptop computer, a notebook computer, a tablet, or another such electronic device) and access point 112-1 can communicate wirelessly in a WLAN using an IEEE 802.11 communication protocol. Thus, electronic devices 110 can be associated with or can have one or more connections with access point 112-1. For example, electronic devices 110 and access point 112-1 can wirelessly communicate while: detecting one another by scanning wireless channels, transmitting and receiving beacons or (equivalently) beacon frames on wireless channels, establishing connections (for example, by transmitting connect requests), and/or transmitting and receiving packets or frames (which can include the request and/or additional information, such as data, as payloads). Note that access point 112-1 can provide access to a network, such as the Internet, via an Ethernet protocol, and can be a physical access point or a virtual or ‘software’ access point that is implemented on a computer or an electronic device. In the discussion that follows, electronic devices 110 are sometimes referred to as ‘clients,’ ‘stations,’ or ‘recipient electronic devices.’

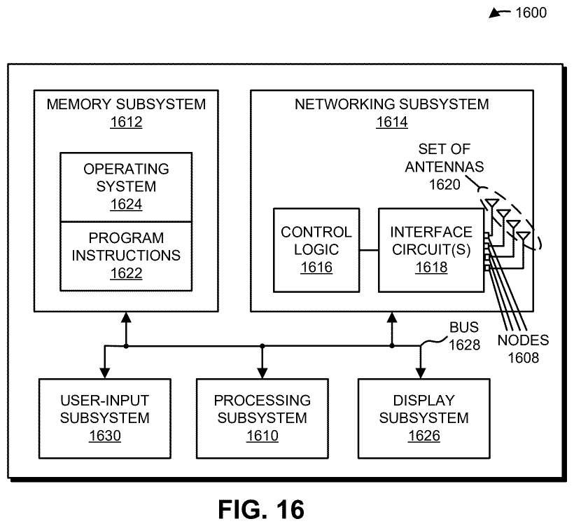

As described further below with reference to FIG. 16, electronic devices 110 and access point 112-1 can include subsystems, such as a networking subsystem, a memory subsystem, and a processor subsystem. In addition, electronic devices 110 and access point 112-1 can include radios 114 in the networking subsystems. More generally, electronic devices 110 and access point 112-1 can include (or can be included within) any electronic devices with networking subsystems that enable electronic devices 110 and access point 112-1, respectively, to wirelessly communicate with another electronic device. This can include transmitting beacon frames on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

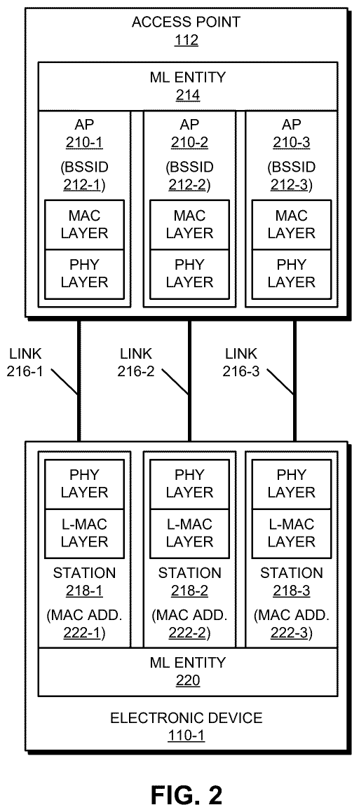

As can be seen in FIG. 1, wireless signals 116 (represented by a jagged line) are communicated by one or more radios 114-1 and 114-2 in electronic device 110-1 and access point 112-1, respectively. For example, as noted previously, electronic device 110-1 and access point 112-1 can exchange packets or frames using a Wi-Fi communication protocol in a WLAN. As illustrated further below with reference to FIGS. 2-22, one or more radios 114-1 can receive wireless signals 116 that are transmitted by one or more radios 114-2 via one or more links between electronic device 110-1 and access point 112-1. Alternatively, the one or more radios 114-1 can transmit wireless signals 116 that are received by the one or more radios 114-2.

In some embodiments, wireless signals 116 are communicated by one or more radios 114 in electronic devices 110 and access point 112-1, respectively. For example, one or more radios 114-1 and 114-3 can receive wireless signals 116 that are transmitted by one or more radios 114-2 via one or more links between electronic devices 110-1 and 110-2, and access point 112-1.

Note that the one or more radios 114-1 can consume additional power in a higher-power mode. If the one or more radios 114-1 remain in the higher-power mode even when they are not transmitting or receiving packets or frames, the power consumption of electronic device 110-1 can be needlessly increased. Consequently, electronic devices 110 can include wake-up radios (WURs) 118 that listen for and/or receive wake-up frames (and/or other wake-up communications), e.g., from access point 112-1. When a particular electronic device (such as electronic device 110-1) receives a wake-up frame, WUR 118-1 can selectively wake-up radio 114-1, e.g., by providing a wake-up signal that selectively transitions at least one of the one or more radios 114-1 from a lower-power mode to the higher-power mode.

IEEE 802.11be has proposed the use of multiple concurrent links between electronic devices, such as access point 112-1 and one or more of electronic device 110. For example, as shown in FIG. 2, which presents a block diagram illustrating an example of electronic devices communicating wirelessly, access point 112-1 can be an access point multi-link device (MLD) that includes multiple access points 210, which are cohosted or collocated in access point 112-1. In the present discussion, ‘cohosted’ or ‘collocated’ means that access points 210 are physically or virtually implemented in the same access point MLD, or are affiliated with the same access point MLD. Note that this meaning of ‘cohosted’ does not indicate that access points 210 have the same primary 20 MHz channel. Access points 210 can have associated BSSIDs 212, and media access control (MAC) and physical (PHY) layers (including separate radios, which can be included in the same or different integrated circuits). Note that access point 112-1 can have an ML entity 214 having an MLD MAC address, an ML identifier, a service set identifier (SSID), and that can provide security for access points 210.

Moreover, access points 210 can have different concurrent links 216 in different bands of frequencies (such as a link 216-1 with a link identifier 1 in a 2.4 GHz band of frequencies, a link 216-2 with a link identifier 2 in a 5 GHz band of frequencies and a link 216-3 with a link identifier 3 in a 6 GHz bands of frequencies) with stations 218 in at least electronic device 110-1, which is a non-access point MLD. These stations can have associated lower MAC and PHY layers (including separate radios, which can be included in the same or different integrated circuits). In addition, electronic device 110-1 can have an ML entity 220 having an MLD MAC address.

For example, the access point MLD can have three radios. One radio can operate on a 2.4 GHz band of frequencies, and the other radios can operate on the 5/6 GHz bands of frequencies. The access point MLD can create three access points 210, operating on a 2.4 GHz channel, a 5 GHz channel, and a 6 GHz channel respectively. The three access points 210 can operate independently, each of which has at least one BSS with different BSSIDs 212. (While FIG. 2 illustrates the access point MLD with three access points 210, more generally the access point MLD can include up to 15 access points with one or more access points in a given band of frequencies.) Moreover, each of the access points 210 can accommodate both legacy non-access point stations as well as non-access point MLD stations 218. Furthermore, each of access points 210 can transmit its own beacon frames using its own BSSID. Additionally, the access point MLD can have ML entity 214, identified by an MLD address (such as an MLD MAC address). This MAC address can be used to pair with ML entity 220 of the associated non-access point MLD stations 218.

Moreover, the non-access point MLD station (e.g., electronic device 110-1) can have two or three radios. One radio can operate on a 2.4 GHz band of frequencies, and the other radios can operate on the 5/6 GHz bands of frequencies. When the non-access point MLD establishes an ML association with the access point MLD, it can create up to three stations 218, each of which associates to one of access points 210 within the access point MLD. Each of stations 218 can have a different OTA MAC address 222. The non-access point MLD can also have ML entity 220, identified by another MLD address (such as another MLD MAC address). This MLD MAC address can be used to pair with ML entity 214 of the associated access point MLD.

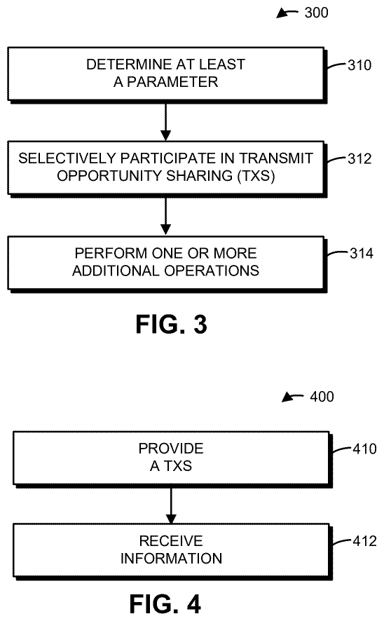

Referring back to FIG. 1, as noted previously, TXS can adversely impact the performance of one or more electronic devices, such as one or more of access points 112. In order to address these problems, as described further below with reference to FIGS. 3-14, in the communication techniques one or more of access points 112 (such as access points 112-1 and 112-2) and/or one or more of electronic devices 110 can perform the communication techniques.

Notably, access point 112-1 can determine at least a parameter indicating an amount of time access point 112-1 shares with at least access point 112-2 in one or more TXOPs of at least access point 112-1, and a second amount of time access point 112-1 receives from at least access point 112-2 in one or more second TXOPs of at least access point 112-2. Then, access point 112-1 can selectively participate in TXS during a subsequent TXOP of access point 112-2 based at least in part on at least the parameter and a threshold value. For example, access point 112-2 can provide, addressed to access point 112-1, a TXS during a subsequent TXOP. After receiving the TXS, access point 112-1 can provide, addressed to access point 112-2, information indicating whether the TXS is accepted. This information can be received by access point 112-2.

Note that the selective participation can be based at least in part on a comparison of at least the parameter and the threshold value.

Moreover, at least the parameter can include a sharing parameter corresponding to the amount of time and a shared parameter corresponding to the second amount of time, where the selective participation can be based at least in part on the sharing parameter, the shared parameter and the threshold value. Note that the selective participation can be based at least in part on a comparison of the sharing parameter and the threshold value, and a second comparison of the shared parameter and the threshold value. Furthermore, the selective participation can be rejected when the comparison and/or the second comparison violate an acceptance criterion. In some embodiments, the acceptance criterion can include a predefined value in a time interval.

Additionally, at least the parameter can be determined on a per-access point basis.

In some embodiments, at least the parameter can be determined on a per-access category basis and the selective participation can be allowed when an access category of data to be communicated during the TXS equals or exceeds a predefined priority. Note that the predefined priority can be associated with a specified access category in the TXS. Moreover, one or more predefined access categories can include voice and/or video.

Furthermore, the selective participation can be allowed for data having one or more predefined access categories. For example, the one or more predefined access categories can include voice and/or video.

Additionally, at least the parameter can ensure fairness, during the TXS, among electronic devices (such as access points 112), which can include access point 112-1 and access point 112-2.

In some embodiments, access point 112-1 can receive data or provide a trigger frame to one or more associated stations of access point 112-1 (such as electronic device 110-1) during a TXOP and prior to the TXS. Moreover, access point 112-1 can receive, associated with the one or more stations, a block acknowledgement (BA).

Furthermore, access point 112-1 can receive, associated with access point 112-2, the TXS. Additionally, when the TXS during the at least the subsequent TXOP is rejected, access point 112-1 can provide, addressed to access point 112-2, information indicating that the TXS during the at least the subsequent TXOP is rejected. Note that the information can be included in: a CTS frame; or a BSR.

In some embodiments, the TXS can be included in: a multi-user RTS frame; or a BSRP.

Moreover, at least the parameter can be determined on behalf of access point 112-1 and at least access point 112-2.

In summary, the disclosed communication techniques can facilitate improved performance of one or more of access points 112 and/or one or more of electronic devices 110. For example, using the communication techniques, access point 112-1 can maintain its throughput and latency by selectively performing TXS with access point 112-2. In these ways, the communication techniques can improve the user experience when using access point 112-1, access point 112-2, and/or one or more associated stations (such as electronic device 110-1).

While the preceding discussion illustrated communication by access point 112-1, in other embodiments the roles of access point 112-1 and access point 112-2 can be reversed in the communication techniques. Alternatively, in some embodiments, the communication techniques are performed between electronic device 110-1 and electronic device 110-2.

Note that access point 112-1 and one or more electronic devices (such as electronic devices 110-1 and/or 110-2) can be compatible with an IEEE 802.11 standard that includes trigger-based channel access (such as IEEE 802.11ax). However, access point 112-1 and the one or more electronic devices can also communicate with one or more legacy electronic devices that are not compatible with the IEEE 802.11 standard (i.e., that do not use multi-user trigger-based channel access). In some embodiments, access point 112-1 and the one or more electronic devices use multi-user transmission (such as OFDMA). For example, the one or more radios 114-2 can provide one or more trigger frames for the one or more electronic devices. Moreover, in response to receiving the one or more trigger frames, the one or more radios 114-1 can provide one or more group or block acknowledgments to the one or more radios 114-2. For example, the one or more radios 114-1 can provide the one or more group acknowledgments during associated assigned time slot(s) and/or in an assigned channel(s) in the one or more group acknowledgments. However, in some embodiments one or more of electronic devices 110 can individually provide acknowledgments to the one or more radios 114-2. Thus, the one or more radios 114-1 (and, more generally, radios 114 in the electronic devices 110-1 and/or 110-2) can provide one or more acknowledgments to the one or more radios 114-2.

In the described embodiments, processing a packet or frame in one of electronic devices 110 and access point 112-1 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

In general, the communication via the WLAN in the communication techniques can be characterized by a variety of communication-performance metrics. For example, the communication-performance metric can include one or more of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a predetermined or predefined time interval (such as a time interval between, e.g., 1 and 10 s) to an estimated maximum number of bytes that can be communicated in the predetermined or predefined time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices can be present. For example, some embodiments can include more or fewer electronic devices. As another example, in other embodiments, different electronic devices can be transmitting and/or receiving packets or frames. In some embodiments, multiple links can be used during communication between electronic devices 110. Consequently, one of electronic devices 110 can perform operations in the communication techniques.

FIG. 3 presents a flow diagram illustrating an example method 300 for selectively participating in TXS. This method can be performed by an electronic device, such as access point 112-2 in FIG. 1. For example, method 300 can be implemented by an interface circuit in access point 112-2 in FIG. 1. Note that the communication between the electronic device and a second electronic device (such as access point 112-2 in FIG. 1) can be compatible with an IEEE 802.11 communication protocol.

During operation, the electronic device can determine at least a parameter (operation 310) indicating an amount of time the electronic device shares with at least the second electronic device in one or more TXOPs of at least the electronic device, and a second amount of time the electronic device receives from at least the second electronic device in one or more second TXOPs of at least the second electronic device. Then, the electronic device can selectively participate in TXS (operation 312) during a subsequent TXOP of the second electronic device based at least in part on at least the parameter and a threshold value.

Note that the selective participation can be based at least in part on a comparison of at least the parameter and the threshold value.

Moreover, at least the parameter can include a sharing parameter corresponding to the amount of time and a shared parameter corresponding to the second amount of time, where the selective participation can be based at least in part on the sharing parameter, the shared parameter and the threshold value. Note that the selective participation can be based at least in part on a comparison of the sharing parameter and the threshold value, and a second comparison of the shared parameter and the threshold value. Furthermore, the selective participation can be rejected when the comparison and/or the second comparison violate an acceptance criterion. In some embodiments, the acceptance criterion can include a predefined value in a time interval.

Additionally, the electronic device can include an access point and the second electronic device can include a second access point. Note that at least the parameter can be determined on a per-access point basis.

In some embodiments, at least the parameter can be determined on a per-access category basis and the selective participation can be allowed when an access category of data to be communicated during the TXS equals or exceeds a predefined priority. Note that the predefined priority can be associated with a specified access category in the TXS. Moreover, one or more predefined access categories can include voice and/or video.

Furthermore, the selective participation can be allowed for data having one or more predefined access categories. For example, the one or more predefined access categories can include voice and/or video.

Additionally, at least the parameter can ensure fairness, during the TXS, among electronic devices, which can include the electronic device and the second electronic device.

Note that at least the parameter can be determined on behalf of the electronic device and at least the second electronic device.

In some embodiments, the electronic device can optionally perform one or more additional operations (operation 314). For example, the electronic device can receive data or provide a trigger frame to one or more associated stations of the electronic device during a TXOP and prior to the TXS. Moreover, the electronic device can receive, associated with the one or more stations, a block acknowledgement.

Furthermore, the electronic device can receive, associated with the second electronic device, the TXS. Additionally, when the TXS during the at least the subsequent TXOP is rejected, the electronic device can provide, addressed to the second electronic device, information indicating that the TXS during the at least the subsequent TXOP is rejected. Note that the information can be included in: a CTS frame; or a BSR.

In some embodiments, the TXS can be included in: a multi-user RTS frame; or a BSRP.

FIG. 4 presents a flow diagram illustrating an example method 400 for receiving information indicating whether a TXS is accepted. This method can be performed by a second electronic device, such as access point 112-2 in FIG. 1. For example, method 300 can be implemented by an interface circuit in access point 112-2 in FIG. 1. Note that the communication between the second electronic device and an electronic device (such as access point 112-1 in FIG. 1) can be compatible with an IEEE 802.11 communication protocol.

During operation, the second electronic device can provide, addressed to the electronic device, a TXS (operation 410) during a subsequent TXOP. Then, the second electronic device can receive, associated with the electronic device, information (operation 412) indicating whether the TXS is accepted.

In some embodiments of methods 300 (FIG. 3) and/or 400, there can be additional or fewer operations. Further, one or more different operations can be included. Moreover, the order of the operations can be changed, and/or two or more operations can be combined into a single operation or performed at least partially in parallel.

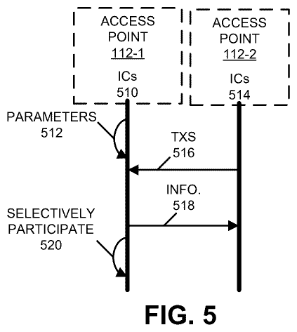

The communication techniques are further illustrated in FIG. 5, which presents a flow diagram illustrating an example of communication between access points 112-1 and 112-2. During operation, one or more interface circuits (or interface circuitry) 510 in access point 112-1 can determine at least a parameter 512 indicating an amount of time access point 112-1 shares with at least access point 112-2 in one or more TXOPs of at least access point 112-1, and a second amount of time access point 112-1 receives from at least access point 112-2 in one or more second TXOPs of at least access point 112-2. Then, interface circuit 510 can selectively participate 520 in TXS 516 during a subsequent TXOP of access point 112-2 based at least in part on at least parameter 512 and a threshold value. For example, one or more interface circuits (or interface circuitry) 514 in access point 112-2 can provide, addressed to access point 112-1, a TXS 516 during a subsequent TXOP. After receiving the TXS 516, the one or more interface circuits 510 can provide, addressed to access point 112-2, information 518 indicating whether TXS 516 is accepted (such as based at least in part on a comparison of at least parameter 512 and the threshold value). This information can be received by one or more interface circuits 514.

While communication between the components in FIG. 5 is illustrated with unilateral or bilateral communication (e.g., lines having a single arrow or dual arrows), in general a given communication operation can be unilateral or bilateral. Moreover, while operations in FIG. 5 are illustrated as being sequential, in some embodiments at least some of the operations can be performed in parallel.

We now further describe embodiments of the disclosed communication techniques. As discussed previously, sharing a TXOP in a channel with a neighboring access point (AP) can enhance the low-latency traffic QoS of a neighboring access point. However, excessive TXOP sharing can also cause unfairness between BSSs. For example, one or more non-access point stations (non-AP STAs) associated with a sharing access point can experience reduced QoS. These challenges can be addressed using the disclosed communication techniques.

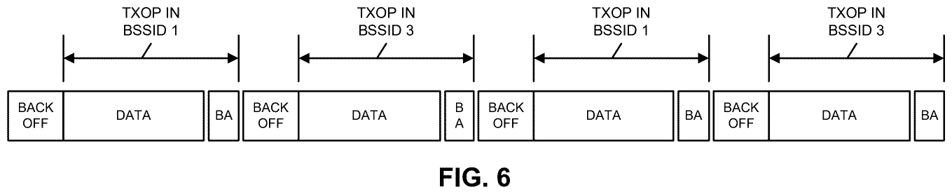

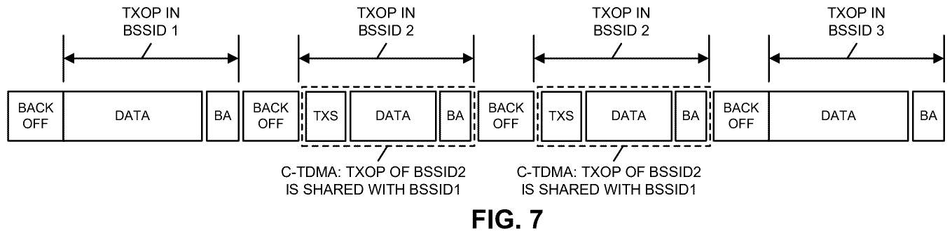

Notably, FIG. 6 presents a drawing illustrating an example of communication between the electronic devices of FIG. 1 or 2. This example shows the baseline scenario in which BSS1 and BSS3 have the same throughput and latency. Alternatively, FIG. 7, which presents a drawing illustrating an example of communication between the electronic devices of FIG. 1 or 2, shows that the throughput and latency of BSS1 are enhanced, as BSS2 shares the TXOP with BSS1, while the throughput and latency of BSS3 are worsened (C-TDMA scenario). For example, BSS2 can contend for the channel even when it has no data to transmit.

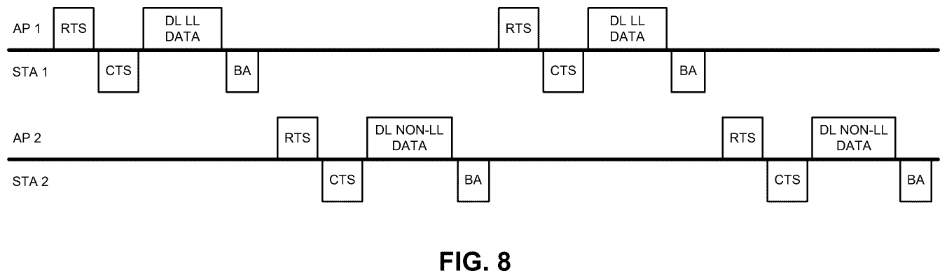

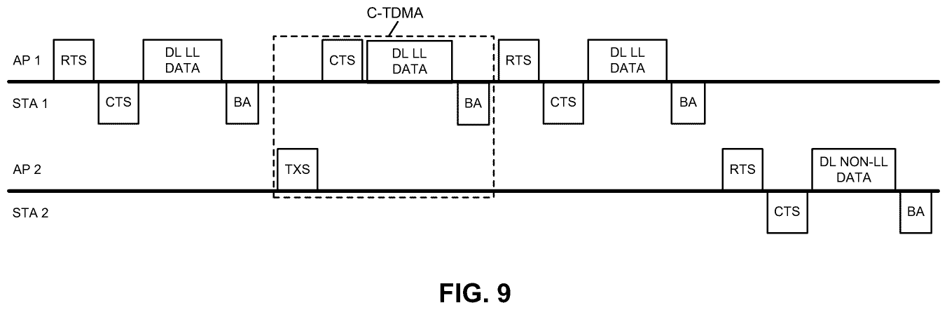

Moreover, FIG. 8, which presents a drawing illustrating an example of communication between the electronic devices of FIG. 1 or 2, shows that station 1 (STA 1) and station 2 (STA 2), associated with access point 1 (AP 1) and access point 2 (AP 2) respectively, have the same or similar throughput and latency. However, FIG. 9, which presents a drawing illustrating an example of communication between the electronic devices of FIG. 1 or 2, shows that the throughput and latency of station 2 are worsened because access point 2, with which it is associated, reduces or eliminates service for station 2. Instead, the TXOP is shared with the neighboring access point 1.

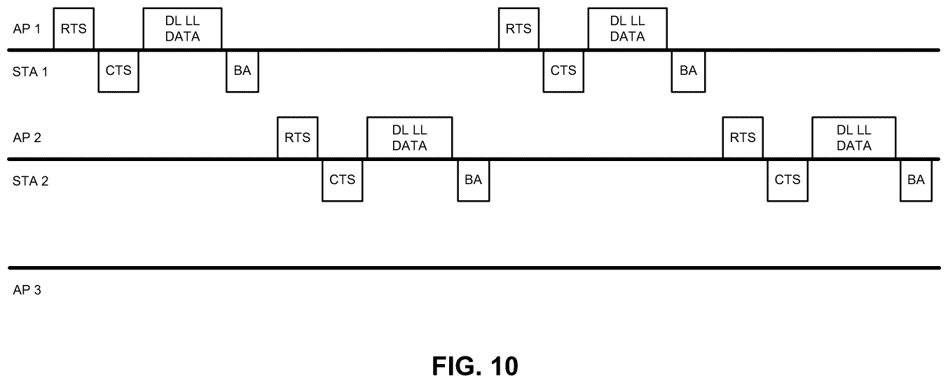

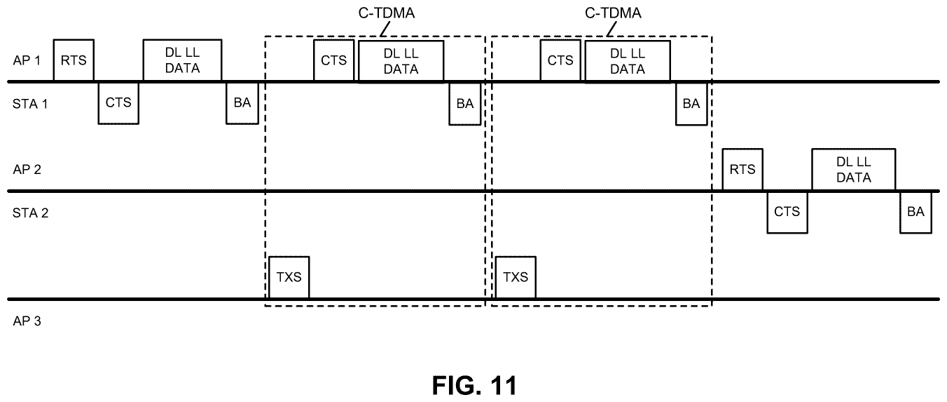

As shown in FIG. 10, which presents a drawing illustrating an example of communication between the electronic devices of FIG. 1 or 2, access point 1 and access point 2 have the same throughput and latency. However, as shown in FIG. 11, which presents a drawing illustrating an example of communication between the electronic devices of FIG. 1 or 2, the throughput and latency of access point 2 are worsened (or reduced) because the neighboring access point 3 participates in the channel access and transfers its TXOP to only access point 1. This can cause access point 2 and its associated station(s) to be unable to access the channel.

In the disclosed communication techniques, the impact of TXOP sharing on neighboring access points and stations can be addressed (e.g., mitigated or otherwise managed) by limiting the amount an access point can engage in TXOP sharing with a neighboring access point, e.g., by allowing up to a specific time ratio, duration, number of TXOPs, etc. that can be shared.

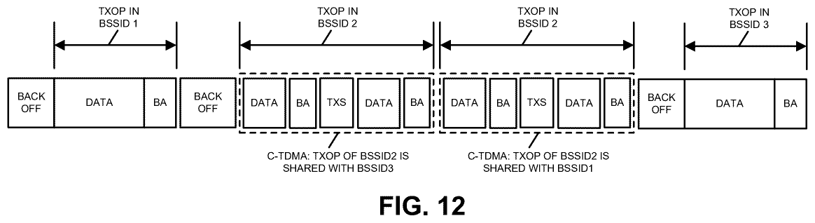

Notably, in multi-access point time sharing, a mechanism can be implemented that ensures fairness between BSSs (such as how much time is shared with a particular access point) to mitigate the impact of TXOP sharing on other BSSs. As shown in FIG. 12, which presents a drawing illustrating an example of communication between the electronic devices of FIG. 1 or 2, the throughput and/or latency of BSS1 and BSS3 can be enhanced by BSS2 fairly sharing one or more TXOPs with BSS1 and BSS3. As there is equitable TXOP sharing, performance degradation for a BSS due to an excessive or imbalanced time allocation in TXOP sharing is avoided.

When sharing a TXOP, note that BSS2 can transmit, to one or more associated stations, one or more data and/or trigger frames. When data is transmitted to one or more associated stations, a block acknowledgement can be optionally transmitted to BSS2 from the one or more associated stations.

The disclosed communication techniques can be used to achieve long-term fairness, e.g., between BSSs. Notably, an access point can maintain how much time it is sharing with one or more, or all, neighboring access points (which is referred to as the ‘sharing time’) and how much time is shared with the access point (which is referred to as the ‘shared time’) by one or more, or all, neighboring access points. The amount of sharing time and/or the amount of shared time can be determined for a time period (e.g., 1 s, 5 s, 10 s, etc.). When either the sharing time or shared time exceeds a threshold (e.g., 250 ms in 5 s), the access point may no longer participate in the multi-access point TXOP sharing procedure, e.g., for the remainder of a predetermined period. When an access point is no longer permitted to participate in multi-AP TXOP sharing, it may not be permitted to share its TXOPs and/or may reject any TXS offer it receives. Compared to limiting the time sharing within the short-term period (e.g., TXOP), the proposed long-term fairness procedure in the disclosed communication techniques can be more efficient. For example, it may improve the dynamics of one or more low-latency traffic characteristics for one or more neighboring access points.

Additionally, in the communication techniques, after obtaining a TXOP, a sharing access point can serve one or more stations associated with it before sharing any part of the TXOP with a neighboring access point (shared access point). In some implementations, a shared access point can only use a shared TXOP for traffic having an equal or higher priority (such as equal or higher access categories (ACs)) as that of the traffic handled by the sharing access point. In some implementations, only a TXOP of voice (VO) and/or video (VI) can be allowed to be shared. For example, this can be implemented because coordinated time domain multiple access (C-TDMA) may be implemented for low-latency traffic (thus, in some embodiments the allowed one or more access categories can be predefined or preset). Note that in some embodiments only VO and/or VI traffic may be communicated in the shared TXOP.

Note that, in some implementations, within a TXOP in which an ultra-high-reliability (UHR) access point that is a TXOP owner performs either coordination-time division multiple access (Co-TDMA) or a TXS mode 2 procedure (in which a non-access point station allocated a TXOP by an access point can return the remaining portion of the allocated time if it finishes its transmission earlier than the allocated time), the access point can use at least 33% of the duration of the obtained TXOP for frame exchanges with its associated stations that include at least one data or management frame. However, when the access point is performing a Co-TDMA in this TXOP and the access point has a Co-TDMA agreement with every other access point whose beacon frame is received by the access point on the primary 20 MHz channel at an RSSI no lower than −72 dBm, then there is no such constraint.

In some embodiments, the one or more access categories allowed to be communicated through TXOP sharing can be signaled or otherwise indicated in a TXS. Note that, after sharing a TXOP, a shared access point can reset a backoff counter based at least in part on the current contention window (CW) for all access categories whose media access control (MAC) protocol data units (MPDUs) were successfully transmitted during the shared TXOP. When the backoff counter is reset, a new backoff value can be invoked (e.g., the new backoff value can be a random value or can be a predetermined or default value). Moreover, when all MPDUs fail during the TXOP, the corresponding CW(s) can increase or stay the same as per the baseline rules, and the corresponding backoff counter(s) can be reset. Note that in some embodiments, for one or more access categories from which at least one QoS data frame was transmitted successfully, the shared access point can update its CW(s). In some implementations, the CW can be updated to a predetermined value, such as a value in the dot11MUEDCATable (however, this rule may not be applied to the associated station(s)).

Moreover, for long-term fairness, an access point can maintain a sharing_time variable and a shared_time variable. After an access point successfully transmits a multi-user request-to-send (MU-RTS) TXS to a neighboring access point: a sharing_time value can equal the sharing_time plus an allocated duration in the transmitted MU-RTS TXS. Moreover, after an access point successfully receives the MU-RTS TXS from a neighboring access point: a shared_time value can equal the shared_time plus an allocated duration in the received MU-RTS TXS. At a predetermined interval, e.g., a dot11TXSAveragingPeriod (e.g., 5 seconds) interval, the sharing_time value can equal the maximum of the sharing_time minus a dot11TXSLimit, 0; and the shared_time value can equal the maximum of the shared_time minus the dot11TXSLimit, 0). In some implementations, the dot11TXSLimit can be 250 ms in a 5 s time interval. In other implementations, the dot11TXSLimit can be any other value of permitted share time within a predetermined time interval. Furthermore, an access point can share the TXOP with any neighboring access point as long as the sharing_time and shared_time values do not exceed a predetermined threshold, e.g., a dot11TXSLimit threshold (such as 250 ms in a 5 s period). In some embodiments, when the access point shares the TXOP with one or more specific access-category restrictions, the sharing_time and shared_time variables can be extended to the sharing_time(AC) and shared_time(AC) to be maintained for the one or more access categories.

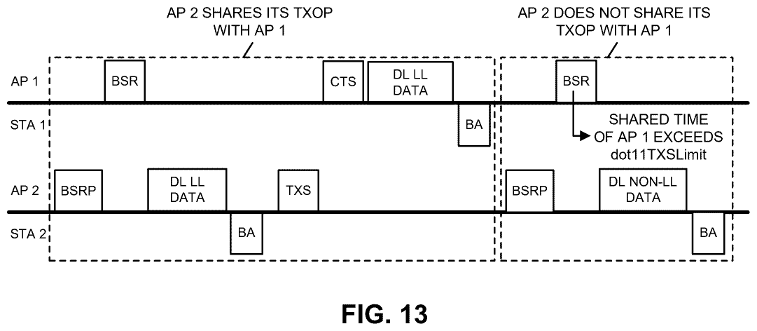

Furthermore, as shown in FIG. 13, which presents a drawing illustrating an example of communication between the electronic devices of FIG. 1 or 2, for long-term fairness, when the shared_time exceeds the sharing threshold, e.g., the dot11TXSLimit threshold (e.g., 250 ms in 5 s), one or more actions can be taken during BSRP reception and/or MU-RTS TXS reception. For BSRP reception, when an access point receives a BSRP from a neighboring access point that indicates the intention of sharing a portion of the time resource of its TXOP, the receiving access point can indicate a rejection, e.g., by providing a status code and/or a buffer status report indicating the rejection. Alternatively, an access point can acknowledge the transmit opportunity sharing using a clear-to-send or CTS frame. The access point also can include a shared_time value and/or unavailable duration to inform the neighboring access point of a reason for the rejection. For MU-RTS TXS reception, when an access point receives a MU-RTS TXS from a neighboring access point that indicates the sharing allocation of the time resource of its TXOP, the access point can provide a status code indicating a rejection. Furthermore, the access point can include the shared_time value and/or unavailable duration in or with the status code.

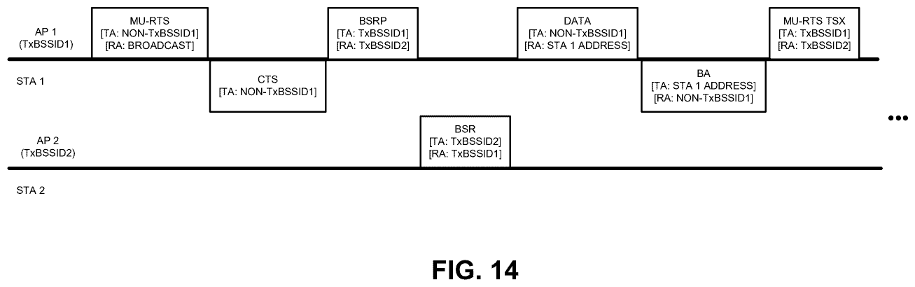

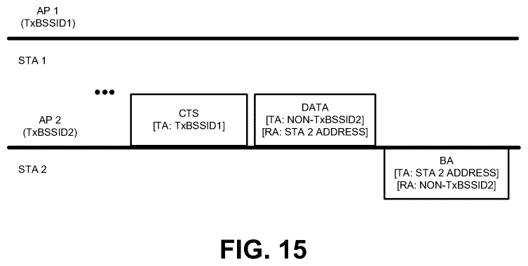

Additionally, as shown in FIGS. 14 and 15, which presents a drawing illustrating an example of communication between the electronic devices of FIG. 1 or 2, in the multiple BSSID case, a single access point (such as the access point associated with the transmitted BSSID) among the multiple access points can share a TXOP with a neighboring access point. The access point performing the sharing can maintain the shared_time and sharing_time (or grant_time) variables. In some embodiments, this approach can simplify the implementation complexity.

Therefore, in multi-access point time sharing, a mechanism can be implemented to balance low-latency traffic QoS enhancements to achieve fairness, e.g., among BSSs, to ensure that one or more non-access point stations within effective communication range do not experience reduced QoS. The disclosed communication techniques provide embodiments of techniques to manage TXOP sharing, including in a manner that provides for fairness.

Note that, for long-term fairness, an access point can maintain a shared_time variable. Notably, after an access point successfully transmits a MU-RTS TXS to any neighboring access point a shared_time value can equal the shared_time plus an allocated duration in the transmitted MU-RTS TXS. Moreover, after an access point successfully receives the MU-RTS TXS from a neighboring access point a shared_time value can equal the shared_time minus the allocated duration in the received MU-RTS TXS. At the predetermined interval, e.g., the dot11TXSAveragingPeriod (e.g., 5 seconds) interval, the shared_time can equal, e.g., the maximum of the shared_time minus a dot11TXSLimit, 0. Furthermore, an access point can share the TXOP with one or more neighboring access points as long as the shared_time does not exceed a threshold, e.g., a dot11TXSLimit threshold (e.g., 250 ms in 5 s).

When access points share time resources more collaboratively and fairly, the QoS for both downlink (DL) and uplink or UL (e.g., triggered by an access point) low-latency traffic can be improved. One reason for the improvement is that resources, e.g., time resources, can be shared among access points and thus the stations associated with them. In some embodiments, because the shared time allocated from one or more neighboring access points is considered a subtraction, only the purely shared time is considered in performing fairness control. However, in some embodiments, there may not be a solution to prevent one or more access points from continuously receiving TXOP sharing from one or more neighboring access point(s). In such cases, an access point near the shared access point may experience unavoidable starvation, e.g., with respect to its ability to access the medium.

Moreover, some embodiments can implement per-access point TXOP sharing. To help ensure long-term fairness, an access point can maintain the shared_time[I] variable for one or more neighboring access point I. For example, an access point can maintain a shared_time[I] variable for each neighboring access point it can observe. After an access point successfully transmits a MU-RTS TXS to a neighboring access point I: a shared_time[I] value can be updated, e.g., to equal the shared_time[I] plus an allocated duration in the transmitted MU-RTS TXS. After an access point successfully receives the MU-RTS TXS from a neighboring access point I, the shared_time[I] value can be updated, e.g., to equal the shared_time[I] minus an allocated duration in the received MU-RTS TXS. Periodically, e.g., at a predetermined interval, such as a dot11TXSAveragingPeriod (e.g., 5 seconds) interval, the shared_time[I] value can equal the maximum of the shared_time[I] minus a dot11TXSLimit, 0. An access point can share a TXOP instance with a neighboring access point I as long as the shared_time[I] value (the amount of time in TXOPs in a time interval that were or are shared with or by the access point) does not exceed a predetermined value, such as a dot11TXSLimit threshold (e.g., 250 ms in 5 s).

When a single access point can share a TXOP up to the dot11TXSLimit time, the disclosed communication techniques can define a finer granularity of time-sharing with one or more neighboring access points. The disclosed communication techniques may provide a better fairness model among the access points participating in the C-TDMA time sharing. However, because the access point needs to maintain more variables, the implementation complexity can be increased over other solutions.

Furthermore, for long-term fairness, an access point can maintain a sharing_time variable and a shared_time variable for one or more neighboring access points, e.g., neighboring access point I. For example, an access point can maintain a respective sharing_time variable and shared_time variable for each access point within effective communication range that is capable of participating in TXOP sharing. After an access point successfully transmits a MU-RTS TXS to a neighboring access point I, a sharing_time[I] value can be updated, e.g., to equal the sharing_time[I] plus an allocated duration in the transmitted MU-RTS TXS. Moreover, after an access point successfully receives the MU-RTS TXS from a neighboring access point I, a shared_time[I] value can be updated, e.g., to equal the shared_time[I] plus an allocated duration in the received MU-RTS TXS. Periodically, e.g., at a predetermined interval, such as a dot11TXSAveragingPeriod (e.g., 5 seconds) interval, the sharing_time[I] can equal the maximum of (sharing_time[I] minus a dot11TXSLimit, 0) and the shared_time[I] can equal the maximum of (shared_time[I] minus the dot11TXSLimit, 0). An access point can share a TXOP with a neighboring access point I as long as the sharing_time[I] and/or the shared_time[I] do not exceed a predetermined threshold, e.g., a dot11TXSLimit threshold (e.g., 250 ms in 5 s).

When a single access point can share a TXOP up to a predetermined threshold, e.g., the dot11TXSLimit time, the described communication techniques can enable a finer granularity of time-sharing portions with one or more neighboring access point. The disclosed communication techniques can provide an improved fairness model among the access points participating in the C-TDMA time sharing. However, because an access point is required to maintain more variables to implement these communication techniques, the implementation complexity can be increased over other solutions.

Additionally, another embodiment can perform TXOP sharing based on access category, such as per-access category TXOP sharing. For long-term fairness, an access point can maintain a shared_time[AC] variable for one or more access categories, e.g., each access category for which TXOP sharing is supported. In association with an access point successfully transmitting an MU-RTS TXS that grants TXOP sharing for an access category to a neighboring access point, a shared_time[AC] can be updated to equal the shared_time[AC] plus an allocated duration in the transmitted MU-RTS TXS. In association with an access point successfully receiving the MU-RTS TXS that grants TXOP sharing for an access category from a neighboring access point, a shared_time[AC] can be updated to equal the shared_time[AC] minus the allocated duration in the received MU-RTS TXS. Periodically, such as at a predetermined interval, e.g., a dot11TXSAveragingPeriod (e.g., 5 seconds) interval, the shared_time[AC] can equal the maximum of (shared_time[AC] minus a dot11TXSLimit, 0). Furthermore, an access point can share a TXOP with any neighboring access point for an access category as long as the shared_time[AC] does not exceed a threshold, such as a dot11TXSLimit threshold (e.g., 250 ms in 5 s).

When an access point shares a TXOP with a neighboring access point, the traffic type that the shared access point can exchange within the BSS can be limited to a specific access category. In such cases, the disclosed communication techniques can enable a finer granularity of time-sharing portions for each enabled access category. This approach can provide an improved fairness model among the traffic types. However, because the access point needs to maintain more variables, the implementation complexity can be increased over other solutions.

Moreover, for long-term fairness, an access point can maintain a sharing_time variable and a shared_time variable for each access category supported. After an access point transmits a MU-RTS TXS that grants TXOP sharing for an access category to a neighboring access point, a sharing_time[AC] value can be updated to equal the sharing_time[AC] plus an allocated duration in the transmitted MU-RTS TXS. Furthermore, after an access point receives the MU-RTS TXS that grants TXOP sharing for an access category from a neighboring access point, a shared_time[AC] value can be updated to equal the shared_time[AC] plus an allocated duration in the received MU-RTS TXS. Periodically, at an interval, such as a dot11TXSAveragingPeriod (e.g., 5 seconds) interval, the sharing_time[AC] can equal the maximum of (the sharing_time[AC] minus a dot11TXSLimit, 0). Furthermore, a shared_time[AC] can equal the maximum of (the shared_time[AC] minus the dot11TXSLimit, 0). Note that an access point can share a TXOP with one or more neighboring access points for one or more access categories as long as the sharing_time[I] and the shared_time[I] do not exceed a threshold, such as a dot11TXSLimit threshold (e.g., 250 ms in 5 s).

When an access point shares a TXOP with a neighboring access point, the traffic type that the shared access point can exchange within the BSS can be limited based on access category, e.g., to one or more specific access categories. In such cases, the disclosed communication techniques can define a finer granularity of time-sharing portions for each access category for which TXOP sharing is supported. This approach can provide an improved fairness model among the traffic types. However, because the access point needs to maintain more variables, the implementation complexity can be increased over other implementations.

While the preceding discussion illustrated the communication techniques with per-access category TXOP sharing, in other embodiments the communication techniques may be used to perform TXOP sharing based at least in part on a group of two or more access categories. For example, an access category group can be defined that includes two or more access categories and the TXOP sharing metrics can be tracked based on the group, e.g., instead of based on an individual access category.

Moreover, while the preceding discussion illustrated the communication techniques using up to two tracking variables (such the shared_time variable and the sharing_time variable) per one or more access points (such as all the neighboring access points or on a per-access point basis) or one or more access categories, in some embodiments, a single tracking variable (such the combination of the information in the shared_time variable and the sharing_time variable) can be used. In some implementations, the amount of TXOP sharing also can be tracked for a group of two or more access points, e.g., as one or more aggregate values, instead of per access point.

In some embodiments, the communication techniques can be implemented in a physical layer and/or a MAC layer.

Note that the formats of packets or frames communicated during the communication techniques can include more or fewer bits, subfields or fields. Alternatively or additionally, the position of information in these packets or frames can be changed. Thus, the order of the subfields or fields can be changed.

While the preceding embodiments illustrate embodiments of the communication techniques using frequency sub-bands, in other embodiments the communication techniques can involve the concurrent use of different temporal slots, and/or or a combination of different frequency sub-bands, different frequency bands and/or different temporal slots. In some embodiments, the communication techniques can use OFDMA.

Moreover, while the preceding embodiments illustrated the use of Wi-Fi during the communication techniques, in other embodiments of the communication techniques Bluetooth or Bluetooth Low Energy is used to communicate at least a portion of the information in the communication techniques. Furthermore, the information communicated in the communication techniques can be communicated or can occur in one or more frequency bands, including: 900 MHz, a 2.4 GHz frequency band, a 5 GHz frequency band, a 6 GHz frequency band, a 60 GHz frequency band, a Citizens Broadband Radio Service (CBRS) frequency band, a band of frequencies used by LTE or another data communication protocol, etc.

As described herein, aspects of the present technology can include the gathering and use of data available from various sources, e.g., to improve or enhance functionality. The present disclosure contemplates that in some instances, this gathered data can include personal information data that uniquely identifies or can be used to contact or locate a specific person.

Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure can broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

We now describe embodiments of an electronic device. FIG. 16 presents a block diagram of an electronic device 1600 (which can be a cellular telephone, a smartwatch, an access point, a wireless speaker, an IoT device, another electronic device, etc.) in accordance with some embodiments. This electronic device includes processing subsystem 1610, memory subsystem 1612 and networking subsystem 1614. Processing subsystem 1610 includes one or more devices configured to perform computational operations. For example, processing subsystem 1610 can include one or more microprocessors, application-specific integrated circuits (ASICs), microcontrollers, graphics processing units (GPUs), programmable-logic devices, and/or one or more digital signal processors (DSPs).

Memory subsystem 1612 includes one or more devices for storing data and/or instructions for processing subsystem 1610, and/or networking subsystem 1614. For example, memory subsystem 1612 can include dynamic random access memory (DRAM), static random access memory (SRAM), a read-only memory (ROM), flash memory, and/or other types of memory. In some embodiments, instructions for processing subsystem 1610 in memory subsystem 1612 include: program instructions or sets of instructions (such as program instructions 1622 or operating system 1624), which can be executed by processing subsystem 1610. For example, a ROM can store programs, utilities or processes to be executed in a non-volatile manner, and DRAM can provide volatile data storage, and can store instructions related to the operation of electronic device 1600. Note that the one or more computer programs can constitute a computer-program mechanism, a computer-readable storage medium or software. Moreover, instructions in the various modules in memory subsystem 1612 can be implemented in: a high-level procedural language, an object-oriented programming language, and/or in an assembly or machine language. Furthermore, the programming language can be compiled or interpreted, e.g., configurable or configured (which can be used interchangeably in this discussion), to be executed by processing subsystem 1610. In some embodiments, the one or more computer programs are distributed over a network-coupled computer system so that the one or more computer programs are stored and executed in a distributed manner.

In addition, memory subsystem 1612 can include mechanisms for controlling access to the memory. In some embodiments, memory subsystem 1612 includes a memory hierarchy that includes one or more caches coupled to a memory in electronic device 1600. In some of these embodiments, one or more of the caches is located in processing subsystem 1610.

In some embodiments, memory subsystem 1612 is coupled to one or more high-capacity mass-storage devices (not shown). For example, memory subsystem 1612 can be coupled to a magnetic or optical drive, a solid-state drive, or another type of mass-storage device. In these embodiments, memory subsystem 1612 can be used by electronic device 1600 as fast-access storage for often-used data, while the mass-storage device is used to store less frequently used data.

Networking subsystem 1614 includes one or more devices configured to couple to and communicate on a wired and/or wireless network (i.e., to perform network operations), such as: control logic 1616, one or more interface circuits (or interface circuitry) 1618 and a set of antennas 1620 (or antenna elements) in an adaptive array that can be selectively turned on and/or off by control logic 1616 to create a variety of optional antenna patterns or ‘beam patterns.’ Alternatively, instead of the set of antennas, in some embodiments electronic device 1600 includes one or more nodes 1608, e.g., a pad or a connector, which can be coupled to the set of antennas 1620. Thus, electronic device 1600 may or may not include the set of antennas 1620. For example, networking subsystem 1614 can include a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 1614 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

Networking subsystem 1614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1600 can use the mechanisms in networking subsystem 1614 for performing simple wireless communication between the electronic devices, e.g., transmitting advertising or frame frames and/or scanning for advertising frames transmitted by other electronic devices.

Within electronic device 1600, processing subsystem 1610, memory subsystem 1612 and networking subsystem 1614 are coupled together using bus 1628 that facilitates data transfer between these components. Bus 1628 can include an electrical, optical, and/or electro-optical connection that the subsystems can use to communicate commands and data among one another. Although only one bus 1628 is shown for clarity, different embodiments can include a different number or configuration of electrical, optical, and/or electro-optical connections among the subsystems.

In some embodiments, electronic device 1600 includes a display subsystem 1626 for displaying information on a display, which can include a display driver and the display, such as a liquid-crystal display, a multi-touch touchscreen, etc. Display subsystem 1626 can be controlled by processing subsystem 1610 to display information to a user (e.g., information relating to incoming, outgoing, or an active communication session).

Moreover, electronic device 1600 can also include a user-input subsystem 1630 that allows a user of the electronic device 1600 to interact with electronic device 1600. For example, user-input subsystem 1630 can take a variety of forms, such as: a button, keypad, dial, touch screen, audio input interface, visual/image capture input interface, input in the form of sensor data, etc.

Electronic device 1600 can be (or can be included in) any electronic device with at least one network interface. For example, electronic device 1600 can include: a cellular telephone or a smartphone, a tablet computer, a laptop computer, a notebook computer, a personal or desktop computer, a netbook computer, a media player device, a wireless speaker, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 1600, in alternative embodiments, different components and/or subsystems can be present in electronic device 1600. For example, electronic device 1600 can include one or more additional processing subsystems, memory subsystems, networking subsystems, and/or display subsystems. Additionally, one or more of the subsystems may not be present in electronic device 1600. Moreover, in some embodiments, electronic device 1600 can include one or more additional subsystems that are not shown in FIG. 16. In some embodiments, electronic device 1600 can include an analysis subsystem that performs at least some of the operations in the communication techniques. Also, although separate subsystems are shown in FIG. 16, in some embodiments some or all of a given subsystem or component can be integrated into one or more of the other subsystems or component(s) in electronic device 1600. For example, in some embodiments program instructions 1622 are included in operating system 1624 and/or control logic 1616 is included in the one or more interface circuits 1618.

Moreover, the circuits and components in electronic device 1600 can be implemented using any combination of analog and/or digital circuitry, including: bipolar, PMOS and/or NMOS gates or transistors. Furthermore, signals in these embodiments can include digital signals that have approximately discrete values and/or analog signals that have continuous values. Additionally, components and circuits can be single-ended or differential, and power supplies can be unipolar or bipolar.

An integrated circuit can implement some or all of the functionality of networking subsystem 1614. This integrated circuit can include hardware and/or software mechanisms that are used for transmitting wireless signals from electronic device 1600 and receiving signals at electronic device 1600 from other electronic devices. Aside from the mechanisms herein described, radios are generally known in the art and hence are not described in detail. In general, networking subsystem 1614 and/or the integrated circuit can include any number of radios. Note that the radios in multiple-radio embodiments function in a similar way to the described single-radio embodiments.

In some embodiments, networking subsystem 1614 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein includes receiving signals from other electronic devices and possibly performing one or more processing operations on the received signals).

In some embodiments, an output of a process for designing the integrated circuit, or a portion of the integrated circuit, which includes one or more of the circuits described herein can be a computer-readable medium such as, for example, a magnetic tape or an optical or magnetic disk. The computer-readable medium can be encoded with data structures or other information describing circuitry that can be physically instantiated as the integrated circuit or the portion of the integrated circuit. Although various formats can be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques can be used. Thus, the communication techniques can be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments can be performed in hardware, in software or both. For example, at least some of the operations in the communication techniques can be implemented using program instructions 1622, operating system 1624 (such as a driver for an interface circuit in networking subsystem 1614) or in firmware in an interface circuit networking subsystem 1614. Alternatively or additionally, at least some of the operations in the communication techniques can be implemented in a physical layer, such as hardware in an interface circuit or interface circuitry in networking subsystem 1614. In some embodiments, the communication techniques are implemented, at least in part, in a MAC layer and/or in a physical layer in an interface circuit in networking subsystem 1614.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

Moreover, while the preceding embodiments illustrated the use of wireless signals in one or more bands of frequencies, in other embodiments of the communication techniques electromagnetic signals in one or more different frequency bands are used. For example, these signals can be communicated in one or more bands of frequencies, including: a microwave frequency band, a radar frequency band, 900 MHz, 2.4 GHz, 5 GHz, 6 GHz, 60 GHz, and/or a band of frequencies used by a Citizens Broadband Radio Service or by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein can be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna node configured to communicatively couple to an antenna; and
an interface circuit, communicatively coupled to the antenna node, configured to communicate with a second electronic device, wherein the interface circuit is configured to:
determine at least a parameter indicating an amount of time the electronic device shares with at least the second electronic device in one or more transmit opportunities (TXOPs) of at least the electronic device, and a second amount of time the electronic device receives from at least the second electronic device in one or more second transmit opportunities (TXOPs) of at least the second electronic device; and
selectively participate in transmit opportunity sharing (TXS) during a subsequent TXOP of the second electronic device based at least in part on at least the parameter and a threshold value.

2. The electronic device of claim 1, wherein the selective participation is based at least in part on a comparison of at least the parameter and the threshold value.

3. The electronic device of claim 1, wherein at least the parameter comprises a sharing parameter corresponding to the amount of time and a shared parameter corresponding to the second amount of time; and
wherein the selective participation is based at least in part on the sharing parameter, the shared parameter and the threshold value.

4. The electronic device of claim 3, wherein the selective participation is based at least in part on a comparison of the sharing parameter and the threshold value, and a second comparison of the shared parameter and the threshold value.

5. The electronic device of claim 4, wherein the selective participation is rejected when the comparison, the second comparison or both violate an acceptance criterion.

6. The electronic device of claim 5, wherein the acceptance criterion comprises a predefined value in a time interval.

7. The electronic device of claim 1, wherein the electronic device comprises an access point and the second electronic device comprises a second access point.

8. The electronic device of claim 7, wherein at least the parameter is determined on a per-access point basis.

9. The electronic device of claim 1, wherein at least the parameter is determined on a per-access category basis and the selective participation is allowed when an access category of data to be communicated during the TXS equals or exceeds a predefined priority.

10. The electronic device of claim 9, wherein the predefined priority is associated with a specified access category in the TXS; and
wherein one or more predefined access categories comprise voice, video or both.

11. The electronic device of claim 1, wherein the selective participation is allowed for data having one or more predefined access categories; and
wherein the one or more predefined access categories comprise voice, video or both.

12. The electronic device of claim 1, wherein at least the parameter ensures fairness, during the TXS, among electronic devices, which includes the electronic device and the second electronic device.

13. The electronic device of claim 1, wherein the interface circuit is configured to receive data or provide a trigger frame to one or more associated stations of the electronic device during a TXOP and prior to the TXS.

14. The electronic device of claim 13, wherein the interface circuit is configured to receive, associated with the one or more stations, a block acknowledgement.

15. The electronic device of claim 1, wherein the interface circuit is configured to receive, associated with the second electronic device, the TXS; and
wherein, when the TXS during the at least the subsequent TXOP is rejected, provide, addressed to the second electronic device, information indicating that the TXS during the at least the subsequent TXOP is rejected.

16. The electronic device of claim 15, wherein the information is included in: a clear-to-send (CTS) frame; or a buffer status report (BSR).

17. The electronic device of claim 1, wherein the TXS is included in: a multi-user request-to-send (RTS) frame; or a buffer status report poll (BSRP).

18. The electronic device of claim 1, wherein at least the parameter is determined on behalf of the electronic device and at least the second electronic device.

19. A method for receiving a response, comprising:
by an electronic device:
determining at least a parameter indicating an amount of time the electronic device shares with at least the second electronic device in one or more transmit opportunities (TXOPs) of at least the electronic device, and a second amount of time the electronic device receives from at least the second electronic device in one or more second transmit opportunities (TXOPs) of at least the second electronic device; and
selectively participating in transmit opportunity sharing (TXS) during a subsequent TXOP of the second electronic device based at least in part on at least the parameter and a threshold value.

20. A second electronic device, comprising:
an antenna node configured to communicatively couple to an antenna; and
an interface circuit, communicatively coupled to the antenna node, configured to communicate with an electronic device, wherein the interface circuit is configured to:
provide, addressed to the electronic device, information specifying transmit opportunity sharing (TXS) during a subsequent TXOP; and
receive, associated with the electronic device, second information indicating whether the TXS is accepted.
